(19) United States
(12) Patent Application Publication
(10) Pub. No.: US 2008/0066332 A1
(43) Pub. Date: Mar. 20, 2008

(54) Diameter Measuring Device

(75) Inventors: Stephen Metcalf, Leicestershire (GB); Ian Fletcher, Leicestershire (GB)

Correspondence Address: FISH & RICHARDSON P.C., P.O BOX 1022, MINNEAPOLIS, MN, 55440-1022, US

(73) Assignee: AstraZeneca AB, Sodertalje (SE)

(21) Appl. No.: 11/569,907

(22) PCT Filed: Jun. 1, 2005
(86) PCT No.: PCT/SE05/00825

§ 371 Date: Dec. 1, 2006

(30) Foreign Application Priority Data
Jun. 2, 2004 (SE) 0401408-0

(51) Int. Cl. G01B 21/10; G01C 25/00

(52) U.S. Cl. 33/555.1; 73/1.81

(57) ABSTRACT

Method of detecting a potentially void inhaler can valve (30), which valve (30) is attached to a can (10) by a ferrule crimp (80), comprising the steps: placing the can (10) in a can jig (220) that is arranged to retain the can (10) at a predetermined measurement height with respect to a diameter measuring means (230), measuring the diameter of the ferrule crimp (80) at the predetermined height, and comparing the measured crimp diameter with a predefined interval of acceptance, and if the measured diameter is outside a predefined interval classifying the inhaler can valve (30) as potentially void. There is also provided a crimp diameter measuring device (200) comprising: a base (210), a diameter measuring means (230) supported by the base (210), and a can jig (220) supported by the base (210), the can jig (220) being arranged to retain a can (10) placed therein at a predetermined measurement height with respect to a diameter measuring means (230).

The present invention relates to the art of inhaler devices, and in particular to a method of detecting a potentially void inhaler can valve, in which valve is attached to the can by a ferrule crimp, and a device for performing the detection.

### BACKGROUND OF THE INVENTION

Many types of medicines are provided in fluid form, such as a solution or suspension of particles in a propellant or emulsion, and are adapted for oral inhalation by a patient. As one example, a container might contain asthma medicine such as fluticasone propionate. During a typical manufacturing process, the container is sealed with a cap that includes a metering valve. The seal is effected by crimping the valve cap onto the neck of the container. The container is then, many times, charged through the valve stem with an aerosol or other propellant.

In order to deliver medicine to the patient, the can operates in conjunction with an actuator as a system commonly known as a metered dose inhaler (MDI) system. The actuator includes a housing having an open container-loading end and an open mouthpiece. A nozzle element is disposed within the housing and includes a valve stem-receiving bore communicating with a nozzle orifice. The orifice is aimed toward the mouthpiece. In order to receive a properly metered dosage of medicine from the container, the patient installs the container into the actuator through the container-loading end until the valve stem is fitted into the receiving bore of the nozzle element. With the container so installed, the opposite end of the container typically extends to some degree outside the actuator housing. The patient then places the mouthpiece into his or her mouth and pushes downwardly on the exposed container end. This action causes the container to displace downwardly with respect to the valve stem, which in turn unseats the valve. Owing to the design of the valve, the design of the nozzle element, and the pressure differential between the interior of the container and the ambient air, a short burst of precisely metered, atomized medicine is thereby delivered to the patient.

FIG. 1 shows a sectional view of one embodiment of an inhaler container 10 (can). The inhaler can 10 is comprised of a can 20 and a valve assembly 30. Due to the high pressure of the propellant, the valve assembly must be firmly attached to the can 20. FIG. 2 shows the can 20 and the valve assembly 30 before they are attached to each other. The valve assembly is basically comprised of a valve mechanism 40, a gasket 50, a ferrule 60, and a support ring 70. As can be seen in FIG. 1 the valve assembly 30 is attached to the can 20 by a crimp 80, i.e. the lower section 90 of the ferrule 60 is crimped in a crimping apparatus so that it closely clasps the upper section of the can 20. Further, the inhaler can 10 is sealed as the upper edge of the can 20 is pressed against the gasket 50 by the crimp 80.

This design gives a reliable and safe container that is simple to produce. However during production, resulting crimp 80 (crimp quality) must be carefully controlled, because if the crimp is made too tight, then an excessive compression force is transmitted via the support ring 70 to the valve mechanism 30, which force may negatively affect the valve operation and potentially make it void. On the other hand if the crimp is made is to loose, then the valve assembly 30 will not be properly retained or sealed with respect to the can 20. There are presently two methods to control the crimp quality: base of can measurement and on-valve measurement.

The base of can measurement is illustrated in FIG. 3, and is an off-production control in the sense that it is not performed on actual assembled inhaler cans 10. Instead, a can without a valve is placed upside down in a crimping apparatus, which is then actuated to form an “hourglass” shaped indention 100 in the side wall of the can 20. Thereafter the diameter of this indention is measured using vernier calipers as indicated with the arrows in FIG. 3. The measured diameter then gives an indication of the crimp quality for inhaler cans 10 crimped in that particular crimper. Despite that this method is very simple and thus easy to perform for any operator, it has some serious disadvantages in that the production line must be stopped to perform the measurement, and that the method cannot be used retrospectively to test individual assembled inhaler cans 10. Moreover it has recently been found that the indention diameter is not directly proportional to the resulting crimping quality for some crimping apparatus.

The on-valve measurement method simply involves direct measuring of the diameter across the edge of the crimped valve ferrule 60 using vernier calipers as is indicated by the arrows in FIG. 1. As this method offers direct measurement of the crimp profile, it is not crimping apparatus dependent, and the direct measure of the dimension is directly proportional to the resulting crimp quality. Moreover, the method can be retrospectively applied to assembled inhaler cans 10. However, it is very difficult to ensure that a consistent measurement point is used from can to can due to the shape of the ferrule crimp, whereby the resulting measure exhibits very high operator variability.

Due to this high operator variability of the on-valve method, it is generally accepted as unreliable and therefore it is currently not used as a valid method of measuring crimp quality.

### SUMMARY OF THE INVENTION

The object of the invention is to provide a new method of detecting a potentially void inhaler can valve, and a ferrule crimp diameter measuring device, which method and device overcomes one or more drawbacks of the prior art. This is achieved by the method of detecting as defined in claim 1, and the crimp diameter measuring device, as defined in claim 3.

One advantage with such a method of detecting a potentially void inhaler can valve is that the method has very low variability and is operator independent, as the crimp diameter measuring device ensures that all measurements are performed at the correct position for the ferrule crimp.

Another advantage is that the measurements are performed directly on assembled inhaler cans, whereby the production line does not have to be stopped.

Still another advantage is that the obtained measured value is directly proportional to crimp quality, and is crimping apparatus independent.

Still another advantage is that the correct measurement height can be achieved in a reliable and simple manner using a height calibration device

Embodiments of the invention are defined in the dependent claims.

### BRIEF DESCRIPTION OF THE DRAWINGS

The invention will be described in detail below with reference to the drawings, in which

FIG. 1 schematically shows a sectional view of an inhaler can for containing a pharmaceutical substance in a pressurized propellant to be included in an inhalation device.

FIG. 2 shows the inhaler can according to FIG. 1 in an unassembled state.

FIG. 3 illustrates the base of can measurement.

FIG. 4a is a schematic front view of the crimp diameter measuring device according to the present invention.

FIG. 4b is a schematic sectional view of the crimp diameter measuring device according to the present invention in the plane defined by the line L-L in FIG. 2.

FIG. 5 is a bar diagram showing the variability for the prior art methods compared with the method according to the present invention.

FIG. 6 is a diagram that shows initial measurement variations between different measuring devices according to the present invention.

FIGS. 7a and 7b schematically show calibration of the measuring device according to the present invention.

FIGS. 8a and 8b show a height calibration device according to the present invention.

FIG. 9 is a diagram that shows measurement variations between different measuring devices after calibration using a height calibration device according to the present invention.

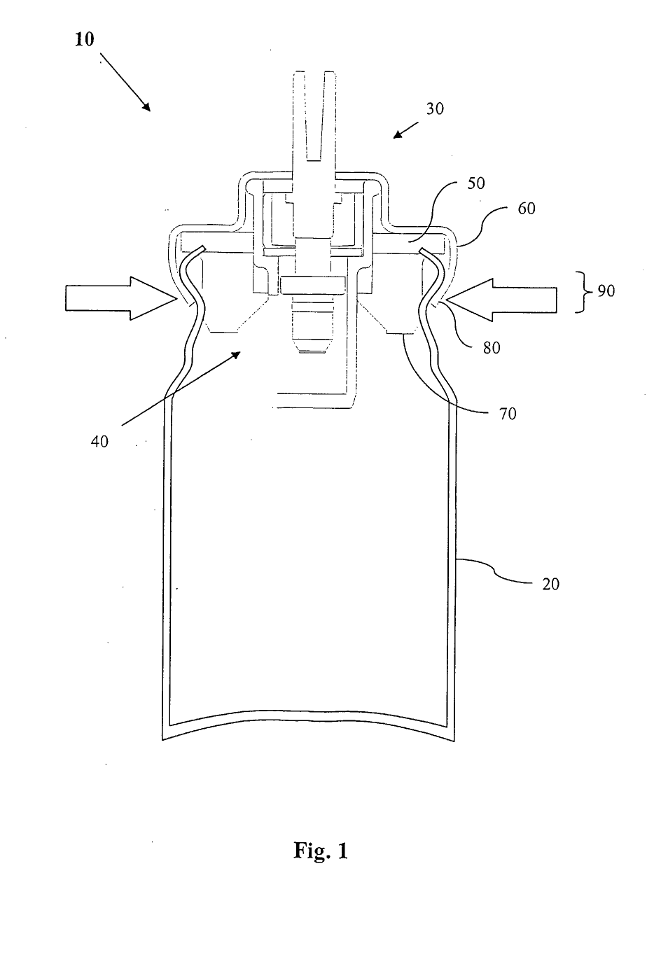

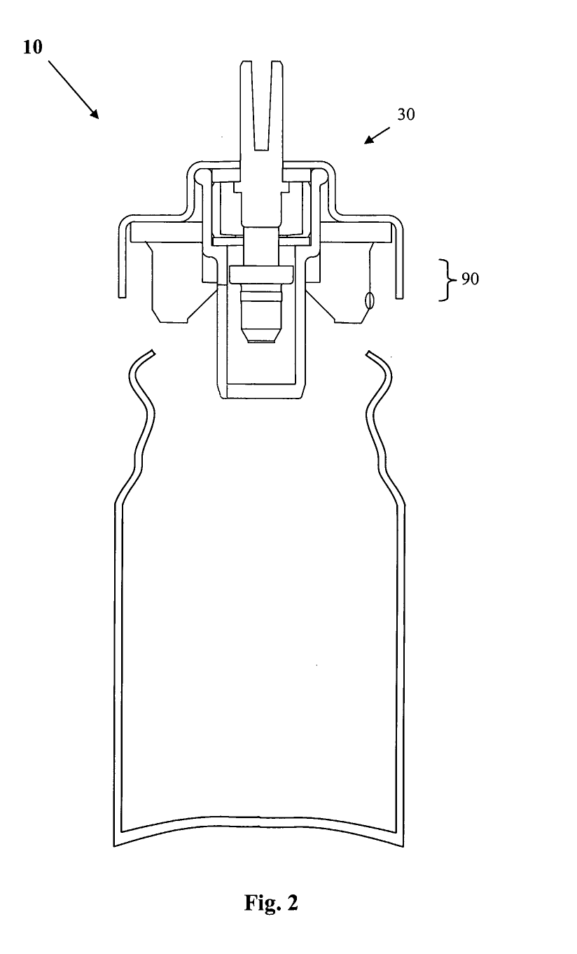

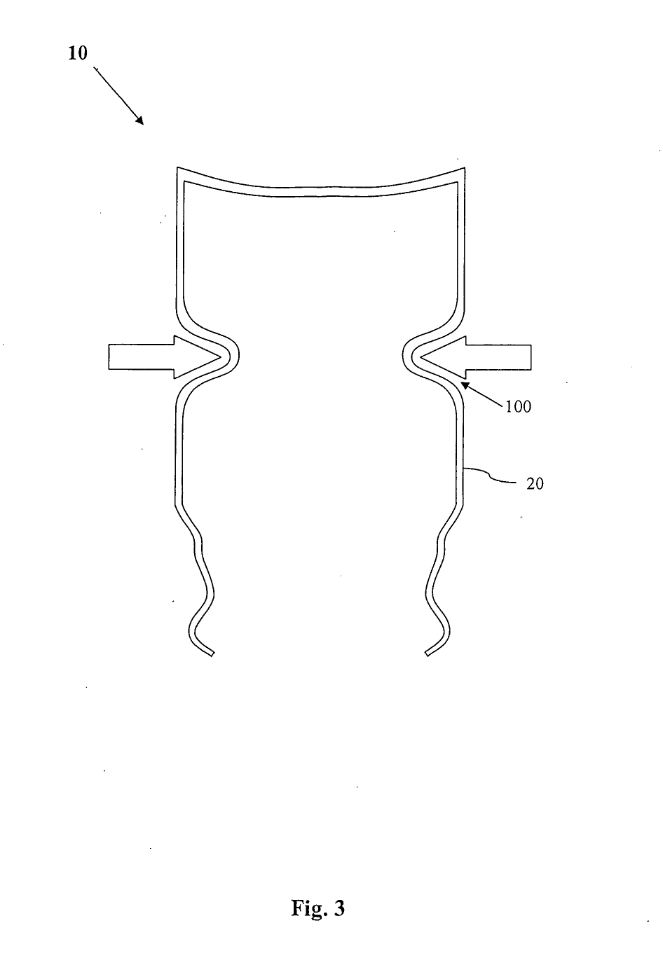

### DETAILED DESCRIPTION OF PREFERRED EMBODIMENTS

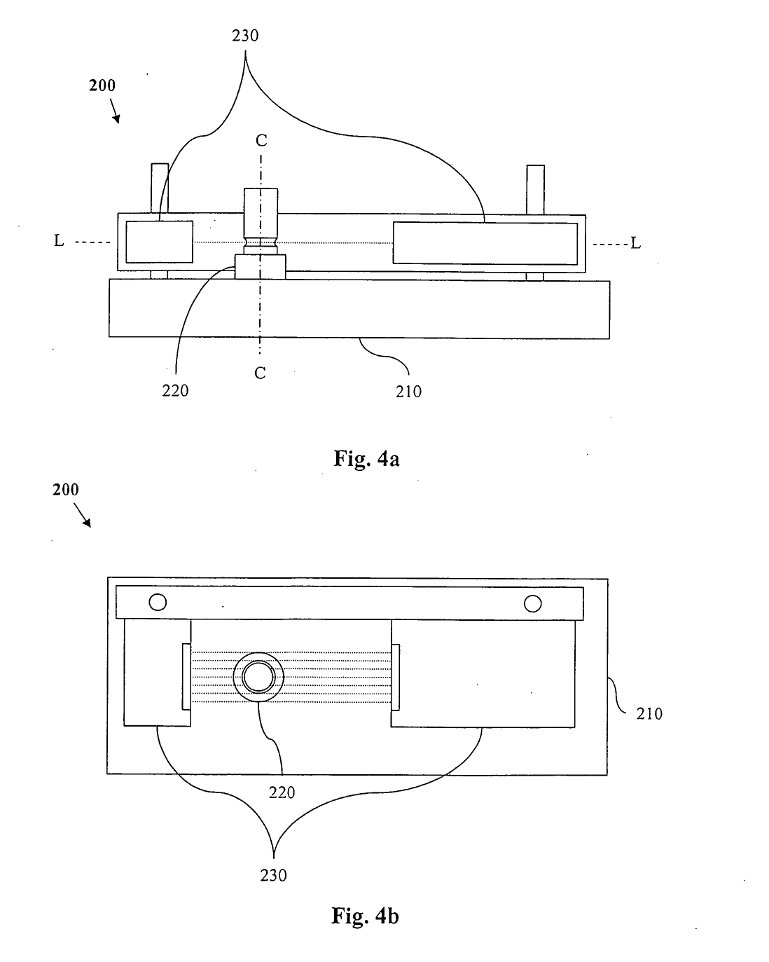

In order to achieve the desired low variability, a dedicated crimp diameter measuring device 200 was developed. FIG. 4a shows a schematic front view of one embodiment of the crimp diameter measuring device according to the present invention. The device 200 comprises a can jig 220 and a measuring means 230 supported by a base 210. The base 210 is basically a rigid element, such as a metal plate or the like. The can jig 220 is formed to receive a can 10 to be measured, such that the crimp 80 is located in the right location for measuring the crimp diameter as is indicated by the line L-L in FIG. 4a. The measuring means 230 is arranged to give the diameter of the crimp 80 on the can 10 placed in the jig 220. The measuring means 230 and the can jig 220 are preferably arranged on the base 210 so that the measurement height can be adjusted in order to fine-tune the device and/or to permit measuring of crimp diameter for cans 10 of different models with the crimp 80 located at different heights. In one embodiment the can jig 220 is fixed in the height direction (C-C) and the measuring means 230 is adjustable in said direction.

The can jig 220 is formed so that an inhaler can 10 placed therein always is positioned in the correct measurement position (measurement height). In one embodiment the can jig 220 is rotatable about its central axis (C-C), whereby a number of measurements can be performed at different rotational angles without need to move the can 10 in the jig 220.

According to one embodiment the measuring means 230 is a non-contact measuring means, such as a laser micrometer or the like, but it might also be contact based measuring means 230 that is arranged to work in the plane as is indicated by the line L-L in FIG. 4a. Preferably the measuring means 230 measure the diameter over a very limited section in the C-C direction, e.g. a laser micrometer with a narrow beam or the like. The use of a narrow measuring means makes it possible to select a precise section of the crimp 80 for the measurement, which makes it possible to select the section that gives the best result. Moreover the device 200 can be used to measure the crimp diameter for cans 10 with a short crimp.

The disclosed crimp diameter measuring device 200 is an all manual device placed outside or besides the production line, whereby an operator places the can 10 in the jig 230 and thereafter reads one or more crimp diameter values in order to check the crimp quality. However, the measuring device 200 can advantageously be automated and connected to a control unit for performing and registering the measurements, and it may also be incorporated directly in an automated production line.

In one embodiment the method of detecting a potentially void inhaler can valve according to the present invention comprises the steps:

placing the can 10 in a can jig 220 that is arranged to retain the can 10 at a predetermined measurement height with respect to a diameter measuring means 230,

measuring the diameter of the ferrule crimp 80 at the predetermined height, and

comparing the measured crimp diameter with a predefined interval of acceptance, and if the measured diameter is outside a predefined interval classifying the inhaler can valve 30 as potentially void.

As is discussed above, the result of the on-ferrule crimp diameter measurement ideally is direct proportional to the crimp quality, that is: if the diameter is too small then the crimp applies an excessive force on the support ring 70 which in turn may transmit a part of the applied force to the valve mechanism 40 which may lead to malfunction of the valve 30, and if the diameter is too large then there is a risk for leakage via the crimp 80. The predetermined interval has to be set for each can/valve assembly combination. The inhaler cans classified as potentially void are discarded or possibly recovered. Inhaler cans that are void due to large crimp diameter could simply be recovered by feeding them into the crimping apparatus a second time.

In order to improve the results from the above method it may further comprise the steps:

registering the crimp diameter,

turning the can 10 in the jig 220 a predetermined angle about a central axis C-C,

repeating the registering and turning a predetermined number of times, and calculating the mean crimp diameter from the registered crimp diameters.

By registering the crimp diameter for several positions, but still at the same measurement height, improved accuracy can be achieved. It is also possible to omit the step of calculating the mean crimp diameter, and instead compare each recorded crimp diameter directly with the predefined interval of acceptance. In the latter case rules have to be set up to specify if it is acceptable with one or more individual crimp diameter values that fall outside the interval of acceptance.

Detailed Example of a Crimp Diameter Measuring Device According to the Present Invention:

A commercially available laser micrometer (Mitutoyo LSM 503) is employed as diameter measuring means, in order to give very accurate measurement of the crimp diameter (up to 5 decimal places). The laser beam of this micrometer is very narrow in the C-C direction, whereby it is well suited for the measuring device according to the present invention.

The can jig is designed to hold the crimp of the inhaler can within the laser beam. The inhaler can is held upside down by the jig, and the crimp diameter is presented to the laser beam. The laser is height adjustable so it can be targeted at a specific part of the crimp. A digital height gauge allows the laser height to be monitored.

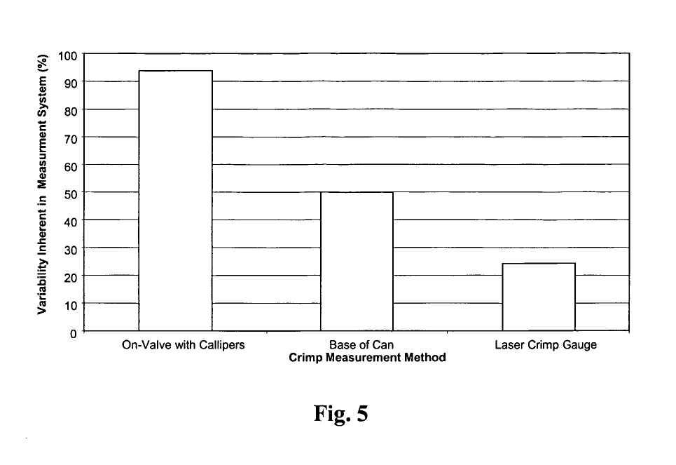

Tests were performed to evaluate the accuracy of the new crimp measuring device. FIG. 5 shows the amount of variability for the prior art methods compared with the measuring device according to the present invention. The more variability induced by the measurement system, the poorer the accuracy.

As is clear from FIG. 5, the laser crimp diameter measuring device is significantly better that the other measurement methods. The variability could be further decreased by taking more measurement points around each can, as this would lower the chances of missing a single very high or very low point. However this also increases the amount of time required to make the measurement, and reduces the convenience as a simple at-line test. The automation of this procedure may be a future enhancement to the device.

Performance within a single measuring device was shown to be acceptable. Based on this information, five new units were furnished. To ensure that all performed to the same level of repeatability when measuring the same unit, a series of test measurements was conducted.

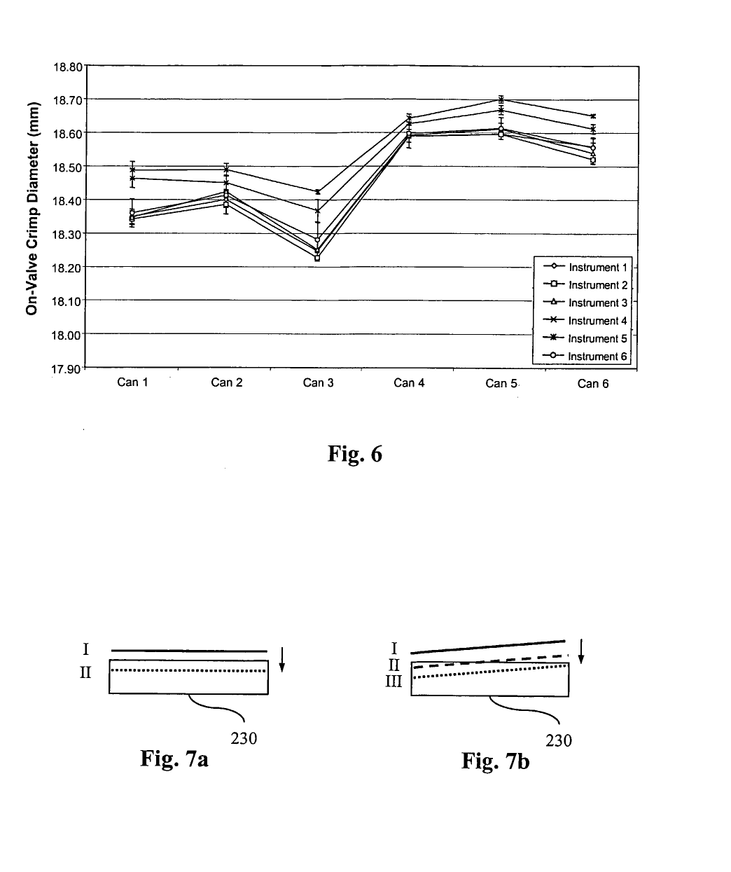

Six inhaler cans, made with two different crimp settings were used for the test. Each can was measured three times with each measuring device. Between each measurement the measuring device was set up from scratch as if it was the start of a new shift. FIG. 6 shows how the on-valve diameter measured for each valve varied across the six measuring device.

Although within a single measuring device the repeatability was good—matching that of the first device (shown as Instrument 1 in FIG. 6)—the agreement between individual measuring devices was not as good.

This was attributed to the method of setting the laser height at exactly 6.60 mm. The method of setting the height first comprises identifying the position of the can jig on which the valve ferrule rests on during the measurement, and then using this as a zero level to raise the laser a predetermined distance, which in this case is 6.60 mm.

This is achieved by lowering the laser micrometer until the beam is completely obscured by the can jig. When this occurs, the display shows an error message, indicating it can no longer detect a diameter. This becomes the zero level, and should be determined very accurately (to 0.01 mm). The height scale is then tared to zero, and the laser lifted by 6.60 mm.

This procedure worked well within one instrument, but is not as good for ensuring consistent height settings from one diameter measurement device to another. These differences were attributed to small misalignments between the laser and the can jig. Ideally both should be arranged perfectly horizontal, so the amount of movement required to obscure the entire laser is very small. However, if the laser is misaligned a slight angle compared to the can jig, the obscuration will be more gradual, making the definition of the zero datum less distinct. The ideal method is schematically shown in FIG. 7a and the later misaligned setup is shown in FIG. 7b.

In practice, the differences in alignment represent the capability of manufacturing the devices, so an alternative calibration method and device were developed that could accommodate such misalignments.

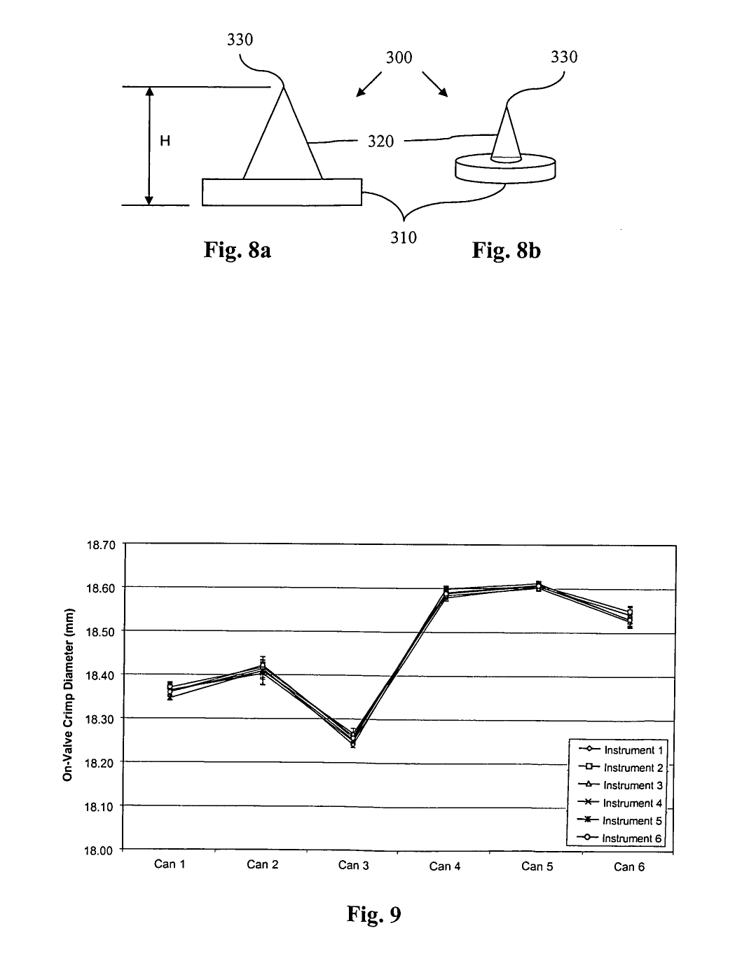

The new calibration method is based upon use of a new height calibration device 300 for a crimp diameter measuring device shown in FIGS. 8a and 8b. The height calibration device 300 comprises a jig support section 310, arranged to fit on the jig in the same manner as a can 10 to be measured, and a height indicative section 320 that extends from the jig support section and which has a point shaped end 330 that terminates at the desired measuring height H for measuring the crimp diameter. In one embodiment, the height indicative section 320 is a cone. Alternatively, the calibration device 300 can be of any suitable height, which then is used as starting level for adjusting the measuring height to the desired value.

There is also provided a method for calibrating the measurement height of a crimp diameter measuring device according to the present invention, comprising the steps:

providing a height calibration device according to above,

placing the height calibration device on the jig,

recording the width of the height calibration device at an intermediate height between the jig support section and the terminating end of the height indicative section, and

incrementally increasing the measuring height until the recorded width is zero.

Alternatively the step of recording comprises setting the initial height above the tip of the height calibration device, whereby the measuring height is incrementally lowered in the last step until the tip diameter is recorded.

Referring again to the example with the six crimp diameter measuring devices of above, a height calibration device, comprised of a pointed cone with a wide flat base, was provided. To set the laser height, the setting piece was placed on the can jig of the gauge, with the laser beam above the cone. At this time the laser micrometer displayed an error as it could not detect anything within the beam. The height of the laser was then slowly lowered until the tip of the cone broke the laser beam, and the laser micrometer displayed a dimension. The exact height at which this occurred was carefully determined, and this became the height for crimp diameter measurements of each individual jig.

Because only the tip of the height calibration device breaks the laser beam, the distinction between nothing in the beam and detection of the setting piece is very clear, minimising the effect of small variations in alignment.

The performance of the crimp diameter measuring devices was then verified with the new height calibration device, the process verification procedure detailed earlier was repeated. The same six cans were measured three times on each measuring device, with a height set-up between each measurement. The results are shown in FIG. 9.

The data shows that the new height setting method provides good repeatability, both within the same measuring device and between measuring devices.

1. Method of detecting a potentially void inhaler can valve (30), which valve (30) is attached to a can (10) by a ferrule crimp (80), comprising the steps:
placing the can (10) in a can jig (220) that is arranged to retain the can (10) at a predetermined measurement height with respect to a diameter measuring means (230),
measuring the diameter of the ferrule crimp (80) at the predetermined height, and
comparing the measured crimp diameter with a predefined interval of acceptance, and if the measured diameter is outside a predefined interval classifying the inhaler can valve (30) as potentially void.

2. Method according to claim 1 where the step of measuring the diameter further comprises the steps:
registering the crimp diameter,
turning the can (10) in the jig a predetermined angle about a central axis C-C,
repeating the registering and turning a predetermined number of times, and
calculating the mean crimp diameter from the registered crimp diameters.

3. Crimp diameter measuring device (200) for detecting a potentially void inhaler can valve (30), which valve is attached to the can by a ferrule crimp (80), comprising:
a base (210),
a diameter measuring means (230) supported by the base (210), and
a can jig (220) supported by the base (210), the can jig (220) being arranged to retain a can (10) placed therein at a predetermined measurement height with respect to a diameter measuring means (230).

4. Crimp diameter measuring device (200) according to claim 3 characterized in that the measuring means (230) is a non-contact measuring means.

5. Crimp diameter measuring device (200) according to claim 4 characterized in that the measuring means (230) is a laser micrometer.

6. Crimp diameter measuring device (200) according to claim 3 characterized in that the measuring height is adjustable.

7. Crimp diameter measuring device (200) according to claim 3 characterized in that the jig (220) is rotatable about a central axis (C-C).

8. Height calibration device for a crimp diameter measuring device (300) according to claim 6 characterized in that it comprises a jig support section (310), arranged to fit on the jig (230) in the same manner as a can (10) to be measured, and a height indicative section (320) that extends from the jig support section (310) and which has a point shaped end (330) that terminates at the desired measuring height for measuring the crimp diameter of the valve attachment crimp (80) on an inhaler can (10).

9. Height calibration device (300) according to claim 8 characterization in that the height indicative section (320) is a cone.

10. Method for calibrating the measurement height of a crimp diameter measuring device (200) comprising the steps:
providing a height calibration device (300) according to claim 8,
placing the height calibration device (300) on the jig (220),
recording the width of the height calibration device (300) at an intermediate height between the jig support section (310) and the terminating end (330) of the height indicative section, and
incrementally increasing the measuring height until the recorded width is zero.
